(19) United States
(12) Patent Application Publication
(10) Pub. No.: US 2005/0179696 A1
(43) Pub. Date: Aug. 18, 2005

(54) Super virtual image generator

(76) Inventor: Ronald J. Swallow, Emmaus, PA (US)

Correspondence Address: Dr. Ronald J. Swallow, 850 Frank Dr., Emmaus, PA, 18049, US

(21) Appl. No.: 11/032,065

(22) Filed: Jan. 10, 2005

Related U.S. Application Data
(60) Provisional application No. 60/536,494, filed on Jan. 15, 2004.

(51) Int. Cl. G06T 15/30; G06T 15/40; G06T 17/00; G06T 11/00; G06T 11/40; G06T 11/20; G06T 15/10; G06T 15/00; G09G 5/00

(52) U.S. Cl. 345/582; 345/423; 345/421; 345/419; 345/427; 345/420; 345/441; 345/552; 345/469; 345/428; 345/586; 345/643

(57) ABSTRACT

The image generator described by this patent is designed to generate in real-time the perspective view in a 3D world consisting of hundreds of millions of polygons, of which 9 million are in the field of view. The hardware achieves this performance by requiring all calculations for a quad polygon to be performed in one clock cycle, down a very deep hardware pipe. This is achieved by organizing the work within 320 small regions of the perspective screen where the required Z-buffer for each region can be implemented by internal cache in the FPGA, and where objects are first sorted into these regions and then their polygons processed, one at a time. Any polygons larger than 3 pixels in perspective size are initially chopped by a power of 2 until less than that size, permitting the hardware pipe to perform all calculations on the polygon components (polygon-lets) in one clock cycle including the 144 calculations of all the Z-buffer values for the sub-pixels under the polygon-lets.

### CROSS REFERENCE TO RELATED APPLICATION

This application claims the benefit of U.S. Provisional Patent Application No. 60/536,494, entitled “Super Image Generator,” filed on Jan. 15, 2004, the disclosure of which is expressly incorporated herein by reference in its entirety.

### FIELD

This invention relates to the generation of real-time images which are perspective views of a 3D world.

### HISTORY OF DEVELOPMENT

The goal of a particular design effort was to seek a chip-set which allowed a user to roam through a 3D world of greatest possible image complexity, resolution, anti-aliasing, with multi-layered fog, multipoint light sources, smooth-shading, general semi-translucent polygons and texture, and a Z-buffer algorithm (to permit all objects to freely move around). A general, less constrained search for a high performance design took place for the first several years, around 8 years ago. Eventually, it became a search for a design which could process one four-sided polygon in one clock cycle, employing a multi-staged pipelined architecture (about 5 years ago). Eventually it was based on the most advanced FPGA capabilities of Xilinx around 3 years ago. This translated to a search for an image generator able to process 9 million four-sided polygons (front and back) in the field of view at a 30 Hz frame rate and a 7 nanosecond clock cycle. Each stage of the pipelined hardware had to perform its algorithm in one clock cycle per register stage. If a portion of the pipe failed that test (some algorithms cannot be achieved by single cycle pipe hardware), that section had to be restructured until the solution was found. When Xilinx came out with the vertex II family, with a large amount of two port cache and 18 bit multipliers, the solution really fell into place. In order to bound the problem to be practical for markets that were price sensitive, the design needed to fit into only two 10 million gate Xilinx chips per chip set which eventually could be converted into an ASIC at a 300 dollar cost to produce.

By structuring the design properly, use of more than one chip-set allows the performance to achieve multiples of the 9 million polygons and greater resolutions. The anti-aliasing requirement during the search changed from a two by two sub-pixel per display pixel to a four by four sub-pixels per display pixel, when it was learned how many gates were needed and that we could stay under two Xilinx chips with the greater anti-aliasing. It was found that in order to achieve one polygon throughput per clock cycle, that polygons needed to be constrained in perspective size so that all the sub-pixels under those polygons could be updated in one clock cycle (requiring 144 parallel z-buffer updates using 144 cache banks, comparators, floating point shifts, etc.). In order not to constrain the user to have to define his whole world as tiny polygons (really not possible since as one approaches any object, a polygon grows in perspective size), the design need to provide a polygon chopper which chopped big polygons on the fly by powers of two, until the pieces were less than 3 pixels in size under which 144 sub pixels could be calculated by the parallel hardware employed there. This chipping also permitted the texture to be structured for assigning a color and translucency to each of these tiny polygon-lets.

Image generators have been designed by may outfits over the last 40 years. They all performed the same basic functions using the same basic techniques to achieve their embodiments. Basically the chip technologies were the constraining and limiting factors. The design that we have come up with here is really quite deductive if one sets his mind to achieving a throughput of one foreword facing polygon every clock cycle using Xilinx FPGA or ASIC technologies. Even the polygon chopper is deductive, since the rendering section of the image generator needed to be limited in the number of z-buffers (144 of them) yet the entire polygon needed to be processed in one clock cycle. It is our firm belief that anyone in the field of designing image generators would be able to come up with a solution quite similar to ours. Fortunately, even with the architecture presented here for patent purposes, there remains a lot of design work for a competitor to complete the design, so that they will earn their rights to employ a similar design, in our opinion, even if they could get around our patent.

But no one else has come up with this design, as yet, except us. It is our purpose here to patent the particular embodiment so that we will be able to freely produce and market the design without finding that someone has succeeded to patent a solution that overlaps our solution in some way. Since, one might argue that this design is not obvious to others, because others have not yet proposed a similar solution, and therefore the particular details of this embodiment will be considered patentable. We leave this decision to the patent office.

We shall seek claims for some of the sections of the hardware, but ultimately it is the collection of the sections together that achieves the full integrated performance. Thus we will seek a claim for the entirety of the design as well.

### OVERVIEW

In order to achieve 36 million four-side front and back-side polygons within the field of view at a 30 hz solution rate with a polygon fill unit working with 12,000 by 8,000 sub-pixels, it is necessary to perform all the computations for a polygon in less than 33(milliseconds)/36(million) i.e. in about one nanosecond. By means of employing a pipelined approach, it is necessary to find a computational approach which uses only one cycle of hardware for each of the many computation stages. Since a one nanosecond cycle time is not possible with FPGAs, the following approach uses four chip sets, each operating with a 7 nanosecond clock working on two polygons per clock cycle, each of 4 chip-sets working with 9 million front and back polygons, producing 4.5 million front sided polygons for further processing at 7 nanoseconds each.

ASIC/FPGA chips have only recently been structured to permit the necessary architecture at a reasonable cost. In particular, a large amount and number of two port cache is now available, permitting a read and write of 144 Z-buffer values in one cycle for a polygon subtending 144 sub-pixels. Thus any polygon less than 12 sub-pixels in width and height can be Z compared and Z-buffered in one cycle. By employing 144 banks of 512 words by 36 bit two port caches, a 32 (in x) by 16 (in y) (i.e. 512) by 144 (sub-pixel) rectangular region of the perspective screen (defining a “bin”) can be solved (i.e. a 384 by 192 sub-pixel region can be internally Z-buffered at a time) if the polygons are first sorted into these regions and the regions sequentially solved. This is in contrast to the use of 144 MOS memory chips for Z-buffer purposes which would require a very large number of input/outputs to/from the FPGAs. A second advantage of not using an MOS memory for Z-buffering is that two cycles would be required per each of the 144 sub-pixel accesses, a read followed by a write-back cycle, since such memory chips are not two port.

In order to solve a 384 by 192 sub-pixel rectangular region (bin) of the perspective screen (¼th of the screen employing 4 chip-sets), the 3D data base must be sorted, so that the polygons for each region are accessible in the order of the regions. This requires that the polygons be defined in small groups (atoms consisting of small meshes of polygons), each group bounded by an invisible bounding rectangular blocking structure. The bounding blocks (each containing an average of more than 128 polygons) are bucket sorted (single pass/single cycle per blocking structure) based on their upper left perspective boundary. Output from this bucket sort unit are the objects that fall into each region (bin), first those in a 384 by 192 sub-pixel region starting at perspective location 0,0, then those starting at perspective location 384,0, then 768,0, . . . location 5760,0. Then the objects starting at line 192, then those starting at line 384, . . . finally those starting at line 3648 are outputted. These 16 by 20 rectangular regions subtend a perspective screen size of 6144 by 3840 sub-pixels which are ¼ of the total desired screen area (12,288 by 7680 sub-pixels). It was necessary to limit the number of regions (for a chip-set) to 320 (16 by 20) so that the number of overlapping polygons per pixel is large enough (i.e. 8). In particular, if the average sized polygon is between one and two pixels in size, the average number of sub-pixels covered per polygon is 40 sub-pixels ((16+64)/2). A sub-pixel screen size of 6014 by 3840 contains about 24,000K sub-pixels or 600K average sized polygons (24000K/40). If 7 nanoseconds is the clock rate, 4.5 million polygons can be processed (33 milli-seconds/7 nanoseconds). This results in 4.7 million/600K or 8 polygons foreword facing overlapping the average sub-pixel.

If FPGAs are used, 7 nanoseconds is a reasonable clock rate. If a true ASIC is employed, this clock rate could be doubled or even quadrupled. However, the external memories would become difficult to communicate with (DDR memory can operate at a 7 nanosecond period, but not much faster. For the present, 7 nanoseconds will be assumed the practical clock period in this paper. Later, conversion from a FPGA solution to an ASIC solution can be attempted with faster clock cycles or when Xilinx, vertex IV, is out with about twice the gates and twice the speed, permitting the performance to double per chip-set to around 18 million foreword and backward facing polygons.

The sorting by objects (each containing an average of 128 or more four-sided polygons) into 320 regions (each 384 by 192 sub-pixels), will require 4 cycles per matrix multiply and blocking structure computation (matrices use four words of main memory), for 4.5 million/128 blocking structures which computes to approximately 3 milliseconds of a frame period.

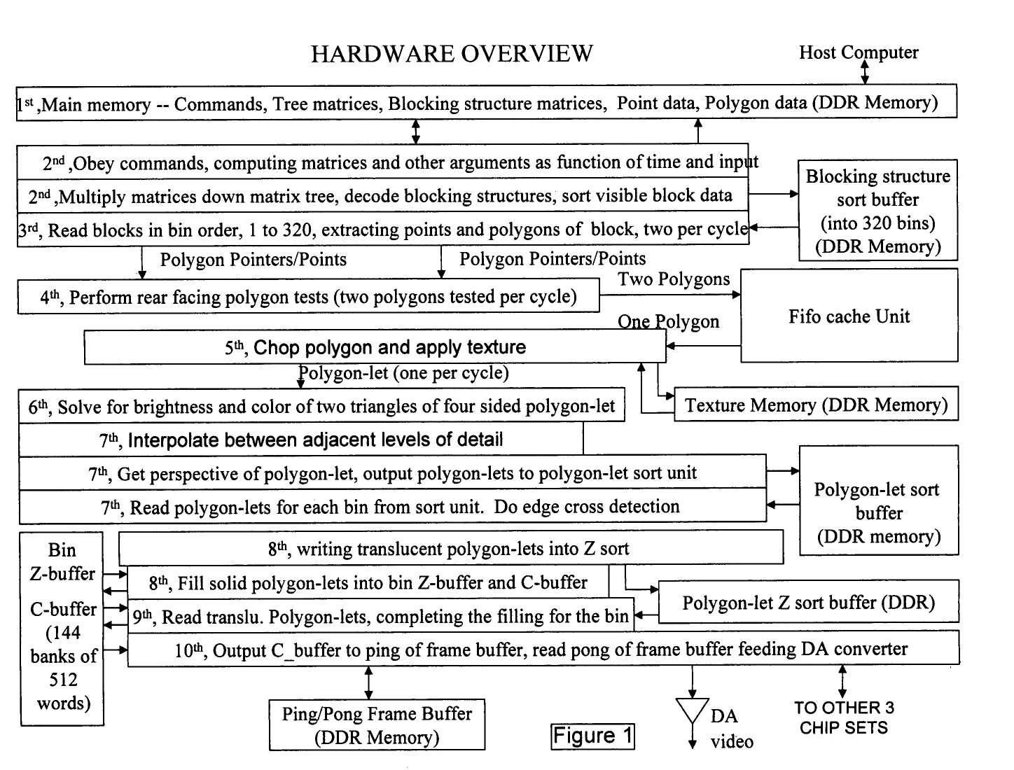

FIG. 1 outlines the major sections of the hardware which is anticipated to require two Xilinx FPGA chips and around 20 DDR MOS memory chips. Main memory holds the entire 3D data base defining the world and how it is to vary in time. A database compiler is required to convert the database input into the format required for the memory, so that the appropriate data can always flow from the memory every clock cycle.

The first stage of the hardware pipe performs the computations required between frame solutions. These computations update the time functions programmed into the database. We don't plan to discuss this portion of the hardware or the use of two power PCs that come with a Xilinx chip for patent purposes.

The second stage contains the hardware that decodes the matrix tree including the testing of visibility of blocks of data. The entire database is traversed by this hardware during around 3 milliseconds in order to extract and sort the “blocks” of data (these objects tend to contain several atoms—point and polygon data) to be decoded by the following hardware during the remaining 30 milliseconds of a frame solution time.

The third stage involves the decoding of atom point and polygon data read from main memory. This decoding includes the transforming of the points into the eye coordinate system and assembling the points and other data of each polygon, so that each polygon can proceed down the hardware pipe independently of each other, as a set of four points, four point normals, and texture pointer.

The fourth stage operates on two polygons per cycle, and determines the polygons direction it faces to the viewer. Output from this stage consists of foreword facing polygons.

The fifth stage chops the polygons by a power of 2 until it projects in perspective to less than three pixels in size. Texture is looked up here, coloring the resultant polygon-lets.

The sixth stage solves for the brightness and color of the two triangles of a polygon-let and transforms the points into the perspective (screen) domain outputting them to a polygon-let sort unit which also serves to buffer those triangles that are out of sort order (required for use in following bins, i.e. the chopper may produce a polygon-let that is out of the bin being worked on, since object polygons larger than bin sizes are permitted.)

The seventh stage interpolates the polygon-lets between two levels of detail, providing a means to switch levels of detail in a nearly undetectable way (especially so, when the polygon-lets are so small and there is not popping between levels of detail). The interpolated polygon-lets are then projected into the perspective domain and outputted to a polygon-let bin sort buffer.

The eighth stage reads polygon-lets from each bin, sending the semi-translucent ones to a z-sort system which uses a 3 pass algorithm to sort those polygon-lets (from far to near) while the solid polygon-lets are filled here. The filling process (rendering) consists of performing the depth calculations for each polygon-let at 144 sub-pixel locations in one clock cycle, updating those of the 144 z-buffers that are closer to the viewer's eye, and in parallel to this z-buffer updating, also updating the corresponding Color buffers for those 144 sub-pixels.

The ninth stage reads back the semi-translucent polygon-lets that have been z-sorted, and renders them into the bin memory, thereby completing the image solution for a bin.

The tenth stage outputs the pixel data from the 144 color cache buffers of a bin as the next bin is begun to be solved (the color buffers are double buffered).

### The Design

Tree Structure Decoding

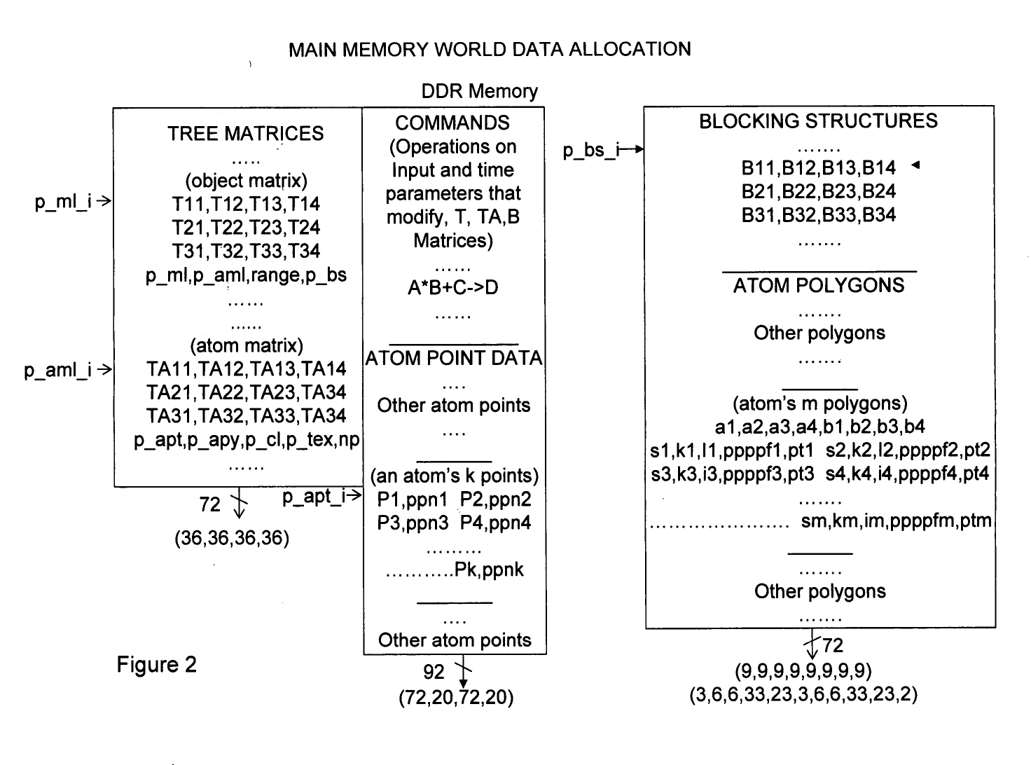

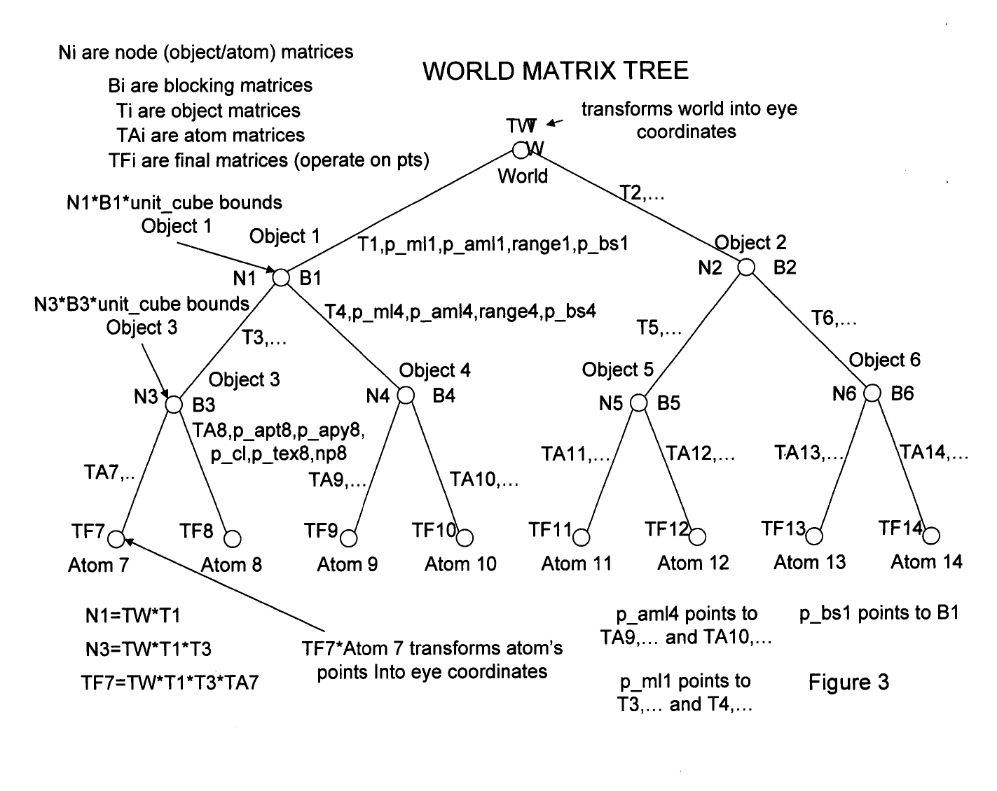

The world is defined by a tree of matrices, see FIG. 3. The main memory layout of the matrix data is shown in FIG. 2. At the top of the tree is a single node with a matrix which transforms the world (defined by the rest of the tree) into the eye coordinate system. Each node branches into two or more nodes with a matrix along each leg to these lower nodes. Each node represents an object below that node. The node at the top of the tree is the object consisting of the entire world; the lower nodes represent object components. At each node of the tree is computed a matrix, N, which is a product of all the matrices, T, from the top of the tree to the node. At each node is a matrix, B, which operates on a unit cube to bound the object defined by the tree at/below this node. N*B places the bounding structure's points in the world coordinate system where they can be tested against the pyramid of view. If it is partially in, the enclosed object (the portion of the tree below this node) is further analyzed. The matrix to this node, T, contains a pointer to the blocking structure, B. It also contains a pointer, p-mi, to a list of matrices, T, which operate on another layer of blocking structures. In addition it contains a pointer, p_aml, which points to another list of matrices which operate on a list of atoms. If operating on a list of matrices operating on atoms, the pointer to this list and the node matrix, N, is sent to a sort unit. When all of the tree has been analyzed, the sort unit outputs groups of atoms ordered from left to right, then top to bottom in the perspective domain, permitting each of 320 regions (bins) of the screen (16 regions in x by 20 regions in y) to be solved one by one. The decision of whether to point to a list of atoms or a list of blocking structures as one goes down the tree, depends upon the distance of the eye to the center of the node's blocking structure. If the distance is greater than the parameter, rangeb, (also attached to the matrix, T, of this node), then the pointer, p_aml to the list of atoms is used and the pointer, p_ml, to the blocking structures below this node is ignored (these blocking structures contain a greater detailed representation of the object when the viewer is closer than rangeb to the object at the above node.

A blocking structure consists of a 12 argument matrix, which operates on a unit cube in order to closely bound a groups of polygons (groups of atoms), positioned in the world by atom matrices. Each atom is built in fix point about an origin and is scaled, rotated and positioned into the world by the atom matrix.

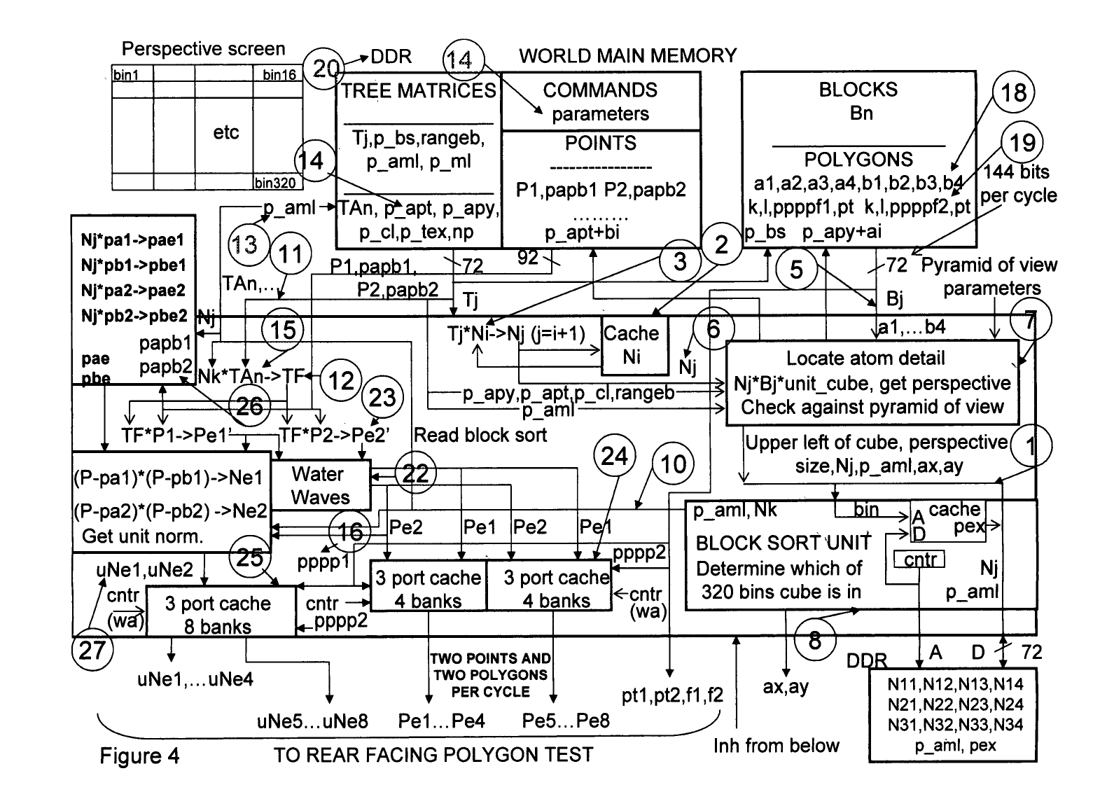

In summary, the world is built of objects, which are built of objects, which are built of objects, etc. The data base structure takes the form of a tree of matrices with blocking structures at each node and atoms at lower nodes of portions of the tree. The hardware scans this tree, multiplies matrices down to each node, checks whether boundary structures at each node are in the pyramid of view, and stacks [2] (see FIG. 4) those that need further sub-blocking structure analysis further down the tree.

Referring to FIG. 4, the output of this hardware are node matrices, N, and the associated pointers to groups of atom matrices, P-aml, (in turn pointing to atoms). As these bounding structures are detected, they are sent to a “block” sort unit [8] for sorting into the 16 rows of 20 rectangular regions of the perspective screen. The details of the tree decoding are shown in more detail than describe here, but generally matrices are read from main memory, are multiplied [3] by those that are stacked in a cache, Ni, ([2] middle of FIG. 4), and are often restacked. For each node matrix, a blocking structure is read from main memory [5], multiplied by the node matrix [6], and the transformed blocking structure is tested against the pyramid of view. Those blocks that are viewable, are passed on with the node matrix to the “block” sort unit [8].

Since the matrix that positions a blocking structure or an atom could be a function of input or time, before some of these blocking matrices are valid and before some of the atom matrices are valid, it is necessary to compute them from products of other matrices and other parameters [9], one or more of which are functions of input or time parameters. Thus, an operation such as A/cache1*B/cache 2+C/cache3→D/cache4 must first be obeyed by pipelined hardware using up to four banks of cache for temporary storage of intermediate results. Operations such as Cos(A/cache1)→B/cache2, Sin(B/cache1)→C/cache2, Sqrt(A/cache1)→B/cache2, and T(ram or cache)*T(ram or cache)→T(ram or cache) are also provided in hardware. (A, B, C, D are main memory locations, cache1, 2, 3, 4 are cache memory locations, and T(ram or cache) is a 12 argument matrix located in main memory or in cache.) Although these computations are performed first by a hardware stage, we don't wish to consider them in this patent.

Atom Data and Sort Unit

Again referring to FIG. 4, the output of the “block” sort unit feeds a multiplier with N [10] and TA [11] matrices generating each matrix, TF [12]=N(node)*TA(atom), which will transform the associated atom point data into the eye coordinate system.

In particular, the blocking structure sort unit outputs for each blocking structure, the pointer, p_aml [13], to a list of atom matrices. Each of these matrices, TA(atom) [14] contains a pointer, p_apt, to an atom's point list, a pointer, p-apy to that atom's polygon list, and the base location of the texture data for that atom. The point list (up to 512 points), consists of a 29 bit x, a 29 bit y, a 29 bit z (integers), and two low resolution points defining a normal (special format) at each point. These points are burst into cache (as they are transformed by TF=N [15] (node)*TA (atom) where they are later addressed by polygon, pppp [16] pointers. The two low resolution points (used to define a normal) are also transformed into the eye coordinate system by TF. The polygon list [18], (pointed to by p_apy) is headed by a word containing 8 nine bit pointers to five levels of atom structure detail. Lastly, the atom matrix contains the number of polygons, NP, in the highest level of detail of the atom, with one bit marking the end of the list of atom matrices. The polygon list [19] consists of four 8 bit pointers (to points) pppp, a flat shade flag, f, and a pointer, pt, to texture data using a 23 bit relative address (relative to the base location associated with the atom matrix). The atom data, (point list and polygon list) occupy 11 banks of main memory (each bank is 18 bits wide made up of DDR [20] memory chips which read/write two words per clock cycle).

The atom is defined by five levels of detail (each level with approximately 4 times more polygons than each previous level. The lower four levels of detail are intended for use when the atom is the farthest away, where the polygons of the lowest level of detail are all less than 3 pixels in size when projected on the screen. As the atom is approached, and the polygons become larger than 3 pixels in size, the level of detail switches to the next higher level of detail where each polygon of the lower level becomes four polygons in the next level of detail. This switching occurs over a small distance range where the transition atom is interpolated from the two levels of detail. When having reached the fifth level (detail having reached around 256 polygons,) further detail is achieved by adding texture. Texture is added by chopping polygons by a power of 2 until they are less than 2 pixels in size. The K*L pieces of a chopped polygon (polygon-let) are colored by a lookup from the texture memory (the two triangular sections of a 4 sided polygon-let are independently colored).

In the range where the atom is being interpolated from two levels of detail, the points of the higher level of detail are paired [24] with point information of the lower level of detail, from which points of the interpolated atom are interpolated.

When atoms are fetched, two points and two polygons are fetched at a time (permitting 9 million polygons to be analyzed). Hardware works on two polygons until the direction of the face of a polygon is determined. Each polygon detected facing forward is passed on for further processing, one polygon at a time thereafter. On the average ½ of the polygons will pass on, resulting in 4.5 million polygons being processed at pipe rate of 7 nanoseconds for eventual Z-buffer rendering.

A water modeling section [22] (FIG. 4), if required, is inserted in the path toward the 8 point cache banks. In essence, this section modulates the altitude of a mesh of polygons while in the eye coordinate system with 8 directional cosine functions of time representing 8 wave components. We choose not to patent this section. The hardware is straight forward and often performed by software in other image generators, such as those of ATI or Nvidia.

Atom Computations

Referring again to FIG. 4, the block sort unit returns, bin sorted, the node matrices, N [10], and a pointer to a list of atom matrices, TA [15], in bin order (320 bins). Using the same hardware used for tree decoding, each TA is read from main memory and multiplied by matrix, N, producing a matrix, TF [12]. The matrix, TA, provides pointers to the points and polygons of an atom. The points of the atom, at p_apt in main memory, are multiplied by the matrix, TF [12], and the results, Pe=TA*P (in eye coordinates), are copied into 8 banks of cache [24], at an incrementing location, starting at zero for each atom, so that later, two polygons, each pointing to 4 points, can be read from the cache banks in one clock cycle. Brightness normals are also transformed at a clock cycle rate, and eventually buffered in another 8 copies of cache [25].

The brightness normal at each point is indirectly defined by two points, p1 and p2, associated with each point, P of an atom. The normal is computed by first transforming the two points, p1 and p2, with the matrix TF that transformed point P into the eye coordinates, forming p1e and p2e [27]. P, p1, and p2 define a plane tangent to the surface at the point P on the atom. Now, Pe, p1e, and p2e are in the eye coordinate system. The cross product between the two vectors from Pe to p1e and to p2e defines a normal perpendicular to the surface tangent at point, Pe, in the eye coordinate system. This normal, N′, is divided by the square root of N′dot N′ yielding a unit normal, uNe, at point, Pe. The unit normal, uNe, is stored at the same address in the second group of 8 caches, as Pe was stored.

Polygon Visibility

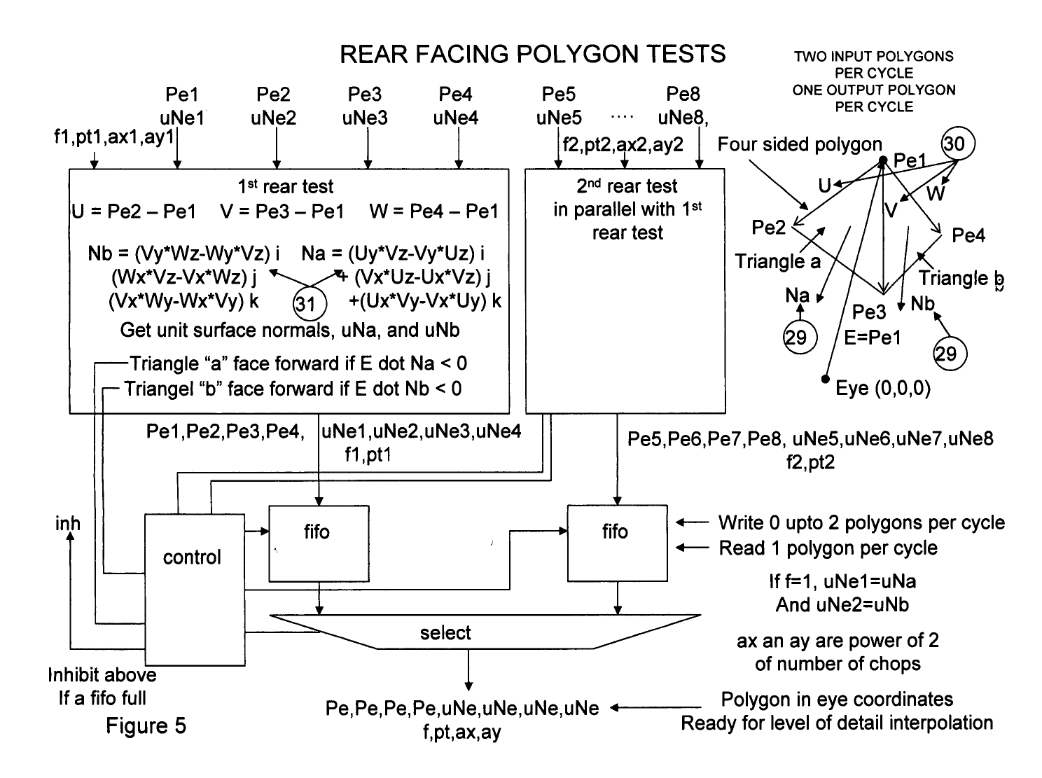

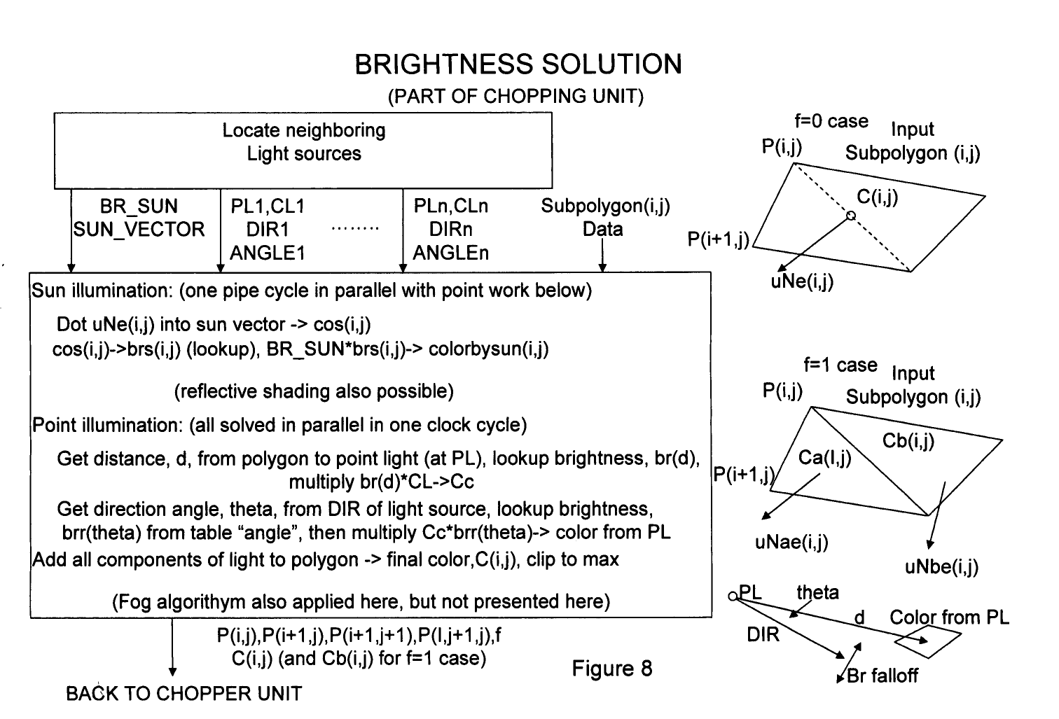

Referring to FIG. 5, the point data (xyzs and normals) are stored in eight copies of cache rather than one copy, so that the polygon pointers for two polygons of the form, pppp, can read the four corners of point data in parallel at the rate of two polygons per clock cycle. In spite of the value of f (smooth shade flag), the normals, Na and Nb [29], to the polygon triangles are calculated from the cross product [31] of two adjacent sides (U, V, and W) [30] of the two triangles. These are dotted into Pe (vector from eye to point, P) and the dot product signs used to determine the direction that the triangles of the polygon are facing, either to the front or back. There are two copies of the point computation hardware up through the surface direction determination, so that two polygons can be processed in one cycle. From this point, only one copy of the hardware is used for following computations at the rate of one polygon per cycle. If f=1, the brightness will be computed from the surface normals of the two triangles of a polygon after the polygon facing direction has been determined (discussed in FIG. 8). Each polygon output from this step consists of xe1, ye1, ze1, . . . , xe4, ye4, ze4, f, and either uNae and uNbe (f=1) or uNe1, uNe2, uNe3, and uNe4 (f=0). In addition, ax and ay have been calculated by the block sort unit which specifies the power of two of the number of chops that the polygon must under go in the two dimensions of the polygon for texturing and to assure that the texels are less than three pixels in size.

When two levels of detail are involved, the four polygons of the higher level of detail and the single polygon of the lower level of detail remain undeleted if any one of those five polygons is visible.

Polygon Chopper

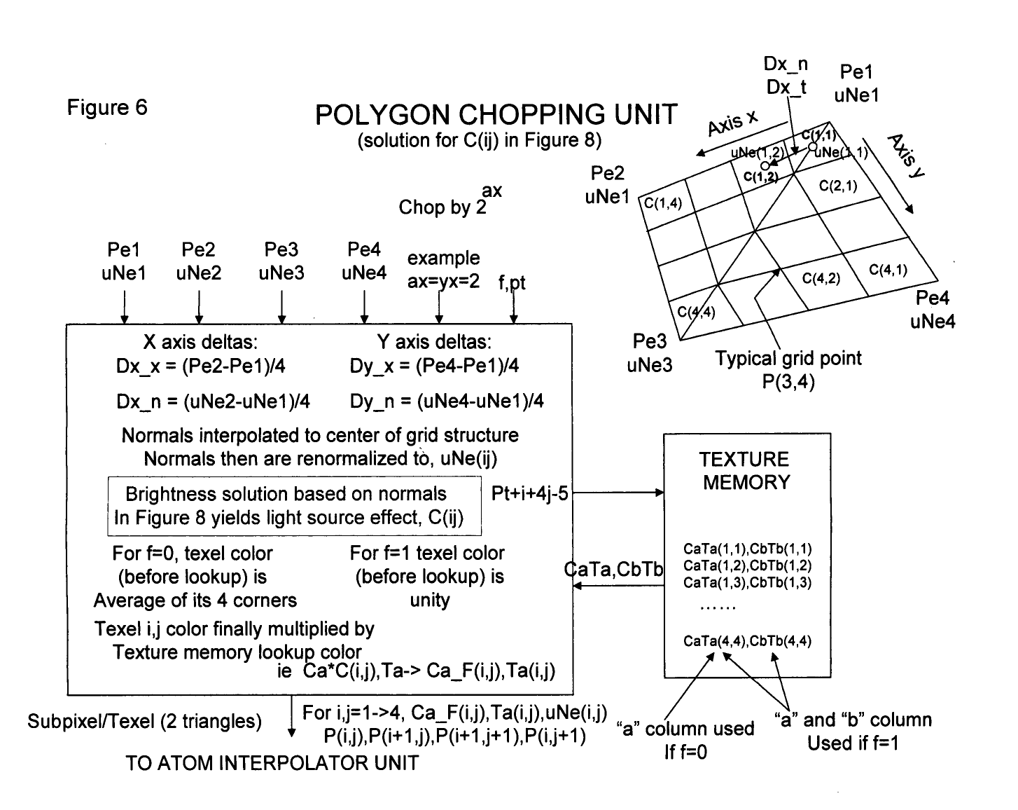

Referring to FIG. 6, the chopper hardware chops the polygon into 2 exp(ax) equal-sized segments along a pair of opposite sides of the polygon and into 2 exp(ay) equal-sized segments along the other pair of opposite sides. These chopped parts (polygon-lets) are fed down the hardware pipe. Those that occur outside the bin being decoded, are non-the-less fully decoded by the following stages up to the second sort unit feeding the rendering engine. This second sort unit will deliver complete sets of polygon-lets per bin to the rendering engine.

After the normals, uNe1 . . . uNe4, of a polygon are looked up by the polygon pointers, pppp, they will be interpolated between endpoints of polygon edges when chopping is done, determining the normal at the center of each polygon-let (polygons produced by the chopping). They, then, will be dotted into unit light source vectors, v_i, producing the cosines of the angles between those vectors, i, and the light sources. These can be used as addresses to a ROM yielding brightnesses (as a function of the angles), br_i, by those light sources at point, Pe which can then be multiplied by the color of those light sources. These components of color energy are then added up to give the total illumination of colored light (from light sources) at the center of a polygon-let. When texture color is looked up, it will be multiplied by the total color derived from that of the light sources. The result, CfT(i,j), at the center of each polygon-let, represent the final colors, Cf(i,j) and translucencies, T(i,j), of the polygon-lets. (CfT(i,j) is short for Cf(i,j), T(i,j)).

If f=1 (flat shaded polygon), the point normals of a polygon are not used to derive the final color of a polygon-let. Instead, the two sides of the polygon (in the eye coordinate system) are used in a cross product for each of the two triangles of the polygon, to produce the normals to the two triangles and its polygon-lets. These normals are used as in previous paragraph for brightness purposes.

If f=0, the chopping interpolates the normals at chop points producing a smooth shading effect. Each texel looks up its texture color and translucency form a texture memory. The color and translucency of the texture look up is multiplied by the total color from the light sources. Texels not in the pyramid of view are not outputted from this section of the hardware. By chopping by a power of two (2 exp(ax/bx)), no divider hardware is needed, but rather shifting achieves the division.

Interpolating Between Two Levels of Detail)

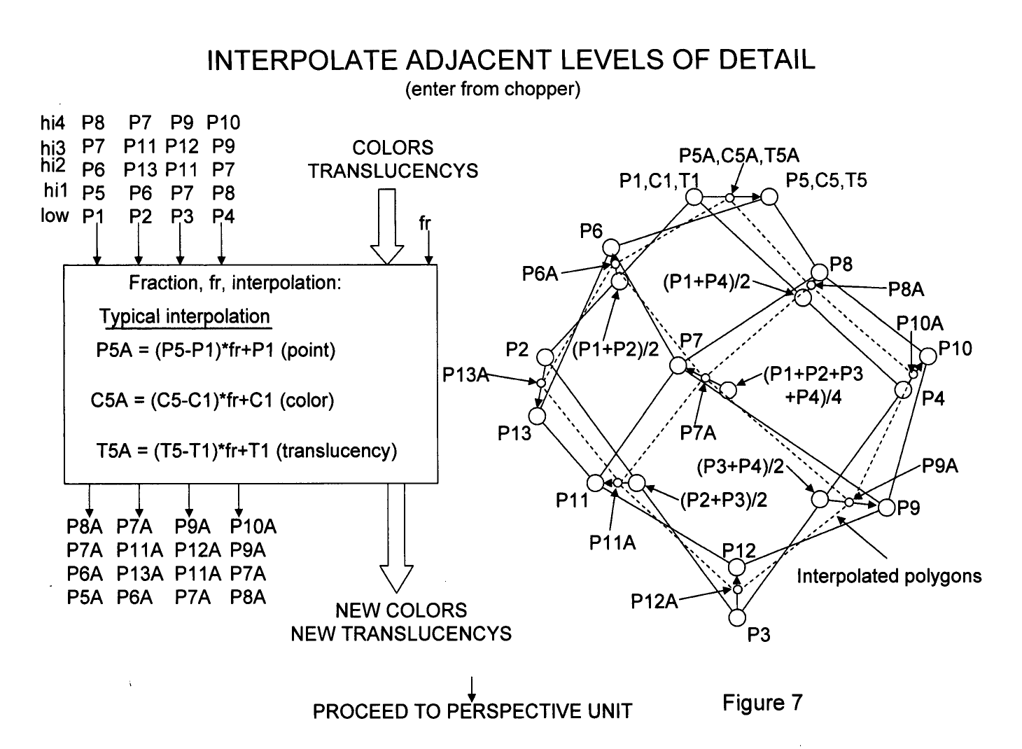

Referring to FIG. 7, when in the range requiring the interpolation between two levels of detail, say fr of the lower detail and 1-fr of the higher detail, the polygon-lets are read from main memory in the order of one lower level of detail, then the corresponding four of the higher detail, then the second of the lower detail, then another four of the higher detail, etc. When the lower detail polygon-let is texeled, its' Cs and Ts are temporally buffered in registers for that polygon texel. When each of the four higher level of detail polygon-let texels pass by, it is possible to read from the registers, the color and translucency of the lower detail texel. Then the higher level is read out with the lower level being read from the temporary registers when needed. The net effect of this color/translucency interpolation, is to fade four polygon-lets of the higher level of detail into the single polygon-let of the lower level of detail.

The interpolated polygon-let texel has the same structure as the higher level polygon-let texel, only its corners have been interpolated between the higher level and corresponding points of the lower level. The fraction, fr, of the higher level and (1-fr) of the lower determines the weighting between the color/translucency of the higher and the lower texel in the determination of the pixel colors of the interpolated polygon-let.

The corresponding points of the lower detail texel are its four corners, the half way points along its edges, and its center.

Perspective

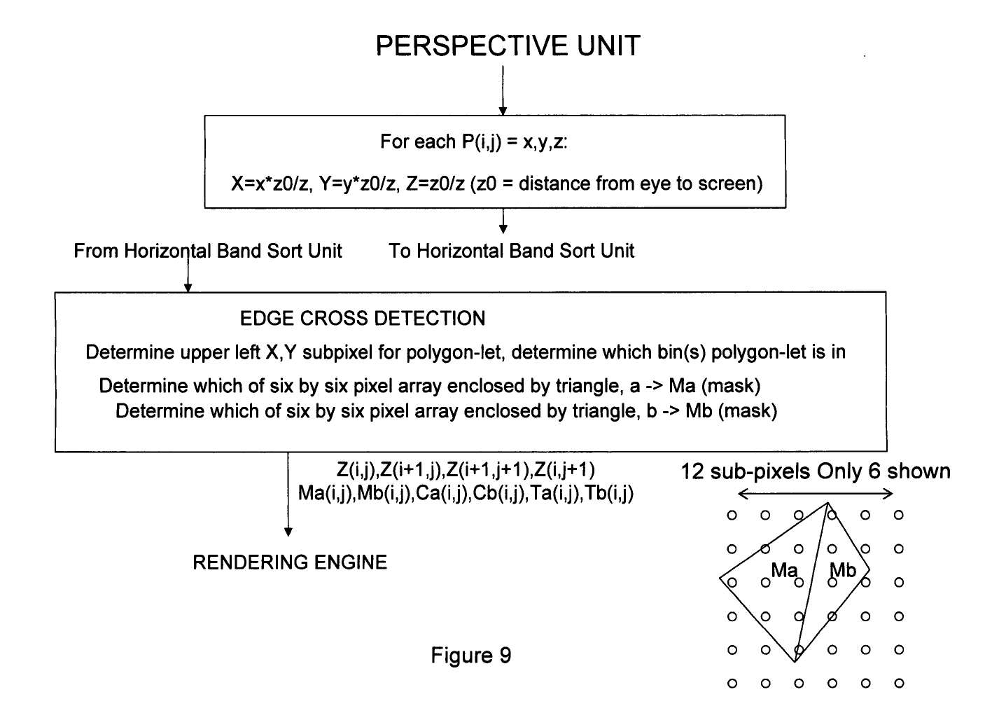

Referring to the upper part of FIG. 9, the four corners of a texel are converted into the perspective domain by the transformations, Xc=xc*z0/zc, Yc=yc*z0/zc, and Zc=z0/zc. If the atom parameters were set up correctly, the texel should not cover more than a 12 by 12 sub-pixel screen area. The parameter, z0, is the distance from eye to the screen.

Horizontal Band Sort

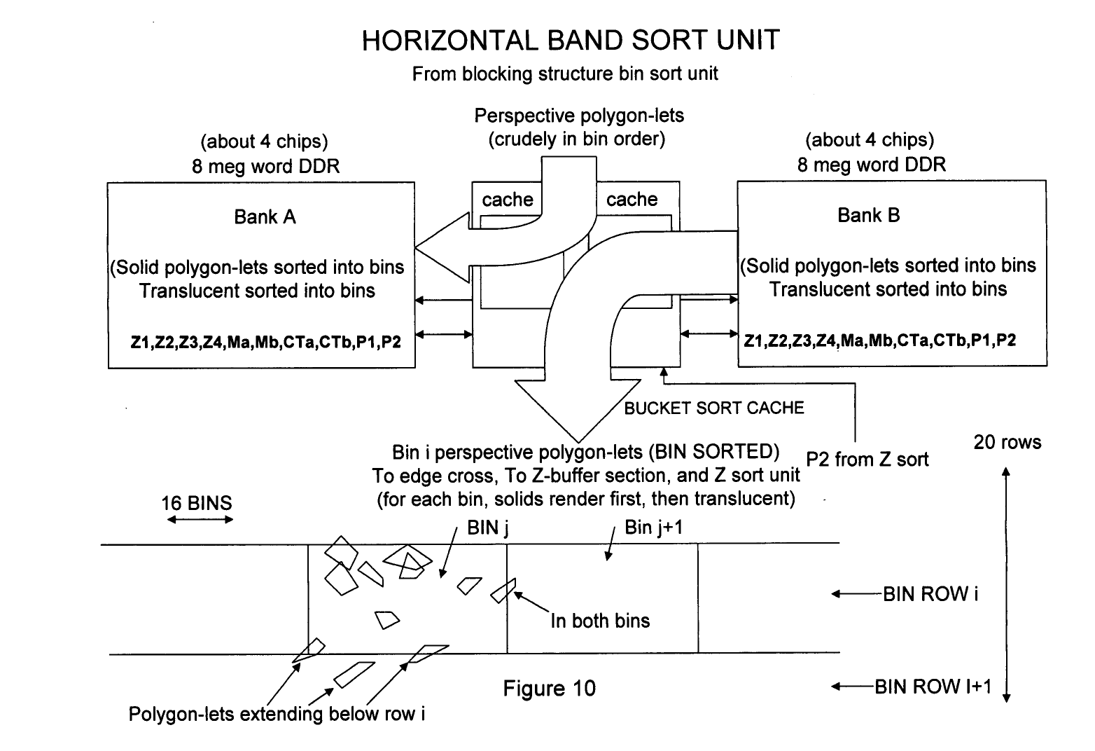

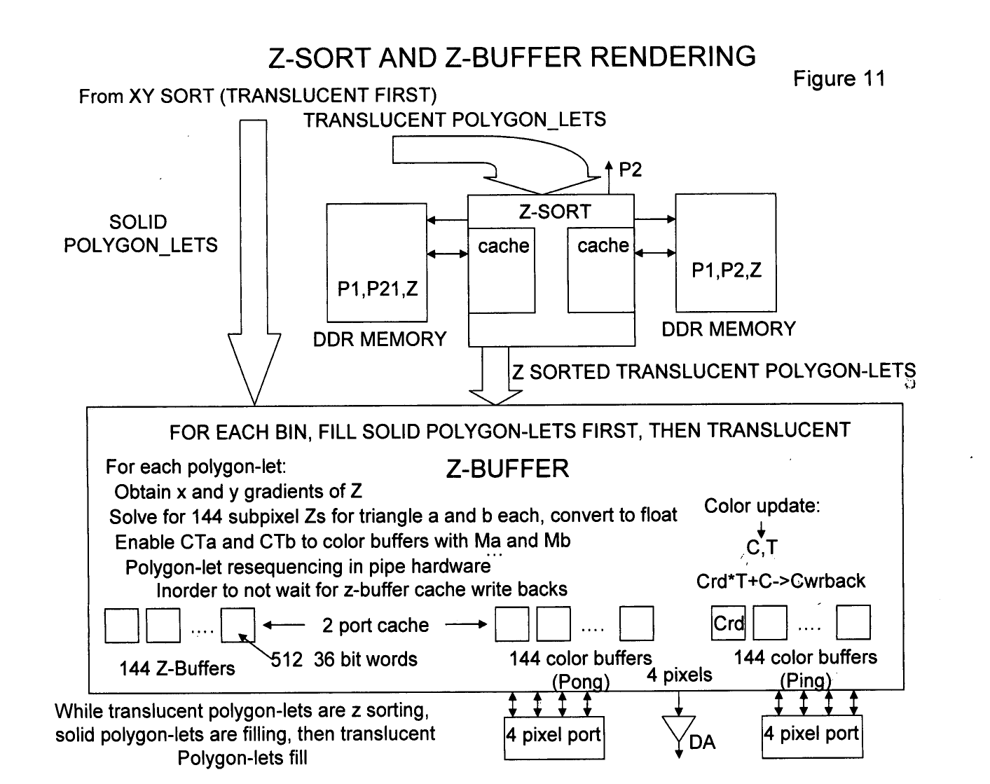

Referring to FIG. 10, the texels with translucency equal to zero (solid polygonlets) are sorted into the following bins corresponding to sixteen rectangular regions of each band of the screen. Referring to FIG. 11, the texels with non-zero translucency are sorted into another set of bins overlapping the first set of bins (same sort unit). When reading, the texels in the first rectangular region (bin) are read first, the texels in the second are read next, etc. in bin order. When reading a bin, both translucent and solid polygon-lets are read in parallel, the solid ones going to the rendering engine, the translucent ones going to the 1st pass of z bucket sort hardware.

The semi-translucent polygon-lets are read and written three times while the solid polygons are being rendered, (sorting on 12 bits, three times for a 36 bit Z sort), then they enter the rendering engine following the processing of the solid polygon-lets and the completion of the 3 pass z sort unit.

Edge Cross Detection

Referring to FIG. 9, lower part, the texel is up and to the left justified in a 12 by 12 area of sub-pixel space, defining an upper-left corner sub-pixel, XY. Each edge of the two triangles of the texel is sub-pixel line cross-detected, determining the sub-pixels to the right and/or left within the area of 12 by 12 sub-pixels defined by XY. It is possible to code which of the 144 sub-pixels are in each of the two triangles with 192 bits. Output from this section is Zc1(29 bits), Zc2(29 bits), Zc3(29 bits), Zc4(29 bits), Zexponent(7 bits), M(192 bits), XY(23 bits), CTa(33 bits),CTb(33 bits). These discarded texels will be decoded when the adjacent bins are processed and decoded.

Each texel entering the rendering engine computes the horizontal and vertical Z gradients for each of the two triangles of the texel. It also computes the upper left Z value at the upper left sub-pixel of the 12 by 12 sub-pixel area for each of the triangles. This format for the Z data permits the use of an array of fixed point adders (sharing one exponent) for the computation of the 144 Z values.

Rendering Engine

Referring to FIG. 11, for Z-buffer work (rendering) using these gradient formatted Zs, 144 Z values are computed for the 12 by 12 area. 144 values are next fix to float converted. 144 cache banks (buffering the Zs for this rectangular region of the screen) are read and compared with the corresponding floated Z values. Z values closer to the eye are written back into these cache banks. In parallel with these computations, the corresponding color data for those 144 sub-pixels are written into cache when the corresponding Z is written back.

When finished with the non-translucent texels, the z-sort unit outputs its texels in Z order, far to near, into the rendering engine. Only those texels whose Z is closer to the eye than obtained from the non-translucent solution are used. When used, the color is read from the cache, multiplied by the T of the texel, and added to the C of the texel. Then it is written back. This is done in all 144 sub-pixels in a clock cycle.

When finished with a rectangular region, the color cache is switched out of the data path, and an identical cache replaces it for continued computations for the next bin. Texels which cross between adjacent bins will have been written into both bins so that there is always a complete set of texels is in each section (bin) of the band.

The “switched out” color cache is read out and fed to the frame color buffer where 4 by 4 areas of sub-pixels are averaged together to produce the pixel data to the buffer. Four pixels are written each clock cycle to the frame buffer until the bin is emptied.

Since image generators have been designed over more than 40 years and the basic math is the same for all of them, many of the sections of this new image generator might appear not patentable. However, each section is required to operate at the speed of one or two polygons per clock cycle and for that reason differ from that of any previous elements of other image generators. For instance, one could design a Xilinx chip without consideration of speed and no special architectural tricks which would not employ anything patentable, yet would produce a working image generator which has specifications that are not optimal.

In our case, speed and performance have been pushed to the limit, requiring unique and patentable structures. The following four claims, 1 through 4 are the chief elements of the above design which represent the main structures that contribute mostly to the great speed and performance. However, without the more encompassing claim, it would be possible for a competitor to patent some component of our design and prevent us from full ownership of our design. Thus, a 5th claim shall be made covering the design in its entirety and detailed by the above design presentation.

1. All polygons at a one cycle clock rate, shall be chopped into pieces smaller than a few pixels in size and fully rendered at that rate.
Polygons larger that a few pixels in size must be chopped by power of 2 until less than a few pixels in size. Polygons less than a few pixels in size are called polygon-lets.
Texture data can be looked up (in one clock cycle) and assigned to each polygonlet.
For a minimum of 4 by 4 anti-aliasing and perspective size less than 3 pixels, 144 z-buffer calculations must be performed in one clock cycle to render a polygonlet.

2. Polygon-lets in one clock cycle, are colored and made translucent by a lookup from a texture memory.

3. Points and polygons are processed at the rate of two points and two polygons per clock cycle until the forward facing polygons are found.
Main memory containing the world data must be able to supply two points and two polygon pointers in one clock cycle
Two points on the average must be transformed into the eye coordinate system in one clock cycle.
Two polygons must be generated every clock cycle, by looking up four points and normals per each of two polygons
This requires employing 8 banks of two port cache, so that eight points/colors can be looked up per clock cycle.

4. Matrix tree processing (during a fraction of a frame solution period) sorts objects into bins for which internal cache z-buffers within the FPGA can be used for rendering.
Matrix tree transformations must be performed down the tree to an object consisting of a small group of atoms (around 128 polygons each) represented by an object containing a small group of atoms, each positioned in the world by an atom matrix. Each of these bottom tree objects is placed in an xy sort bin (320 bins covers a 1500 by 1000 pixel perspective domain, if cache memories are 512 by 36 bits). If object overlaps more than one bin, it only enters the first bin to be decoded.
This sort memory must hold, for each tree bottom matrix, a node matrix and a pointer to the group of atom matrices that make up the object.
These objects are decoded in bin order, generating a polygon-let every clock cycle where each polygon-let can be processed at a single cycle pipe rate.

5. The algorithm defined by the paragraphs 24 through 54 of the above major design section represents our unique approach to achieving the high performance. Together, these paragraphs define an integrated solution to achieving a throughput of approximately one quad polygon per clock cycle.
The order of processing by the various sections of this hardware can be varied while retaining the cost/performance of the presented design. For instance, atom interpolating could be done ahead of the chopping step or the edge cross work could be done before the horizontal band sorting. Other performance features can be added as long as they can be implemented at a pipe rate of one polygon-let per clock cycle.
